(19) United States
(12) Patent Application Publication
(10) Pub. No.: US 2003/0067767 A1
(43) Pub. Date: Apr. 10, 2003

(54) Portable energy-saving lighting device

(76) Inventor: Daniel Liu, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/972,971

(22) Filed: Oct. 10, 2001

(51) Int. Cl. F21L 4/00

(52) U.S. Cl. 362/183; 362/184; 362/207

(57) ABSTRACT

A portable lighting device with an energy-saving control circuit is disclosed. The energy-saving control circuit includes an illumination control switch electrically connected in series with a lamp unit; an illumination-setting unit having a plurality of illumination-setting keys for setting a plurality of illumination levels for the lamp unit and generating an illumination control signal corresponding to one of the illumination levels; and a control unit for receiving said illumination control signal from the illumination-setting unit, and outputting an adjustable pulse-width modulation signal to control the illumination control switch, thereby adjusting the illumination of the lamp unit in accordance with the illumination level set by the illumination-setting unit.

### BACKGROUND OF THE INVENTION

1. Field of the Invention

The present invention relates to a portable lighting device, and more particularly to a lighting device with an energy-saving control circuit.

2. Description of the Prior Art

Generally, a portable lighting device, such as a flashlight, includes only a power switch to control the on or off of a bulb of the lighting device, and the illumination of the bulb thereof is not adjustable. Such portable lighting device has very high bulb illumination when its battery is new, and will have weak bulb illumination as soon as the battery is low. A new battery powers the portable lighting device for about 30 minutes on average and needs replacement frequently that inevitably brings inconvenience to a user.

There are different means to solve the problem of power supply to the portable lighting device, such as providing a charging circuit in the portable lighting device, using a rechargeable battery for the portable lighting device, etc., so that the portable lighting device may be conveniently charged when it is not in use. However, these means do not solve the problem of high power consumption by the portable lighting device, and do not enable a user to adjust the illuminative level of the portable lighting device according to actual need and environmental requirements.

It is therefore tried by the inventor to develop a portable lighting device, of which an electronic switch is switched on and off through pulse width modulation, so that the bulb illumination of the lighting device is adjustable by changing the pulse width ratio to achieve the purpose of reducing electric energy consumed by the portable lighting device.

### SUMMARY OF THE INVENTION

A primary object of the present invention is to provide a portable energy-saving lighting device, in which an electronic switch is switched on and off through pulse width modulation, so that the bulb illumination of the lighting device is adjustable by changing the pulse width ratio to achieve the purpose of reducing electric energy consumed by the portable lighting device.

Another object of the present invention is to provide a portable energy-saving lighting device that may serve as a charging circuit to charge a rechargeable battery in the lighting device with a commercial power or an automobile power supply, and automatically stops charging when the battery is fully charged.

A further object of the present invention is to provide a portable energy-saving lighting device that may serve as an emergency light at a power failure. The portable lighting device functions like a charging circuit when the supply of commercial power is in a normal condition, and automatically switches its power supply to the battery thereof when a power failure occurs.

A still further object of the present invention is to provide a portable energy-saving lighting device that may serve as an emergent help light in case of a disaster or accident by actuating an emergent help light enabling switch thereof to send out Morse code signal or flash light signal.

A still further object of the present invention is to provide a portable energy-saving lighting device that may serve as a dim light at home to provide adjustable illumination.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a front perspective view of a portable energy-saving lighting device according to a first embodiment of the of the present invention in the form of a flashlight;

FIG. 2 shows a flashlight similar to that of FIG. 1 but having differently structured illumination-setting keys;

FIG. 3 is a front perspective view of a portable energy-saving lighting device according to a second embodiment of the of the present invention in the form of an emergency light;

FIG. 4 is a control circuit diagram for the present invention; and

FIG. 5 illustrates different pulse-width modulation signals for controlling the bulb illumination of the present invention.

### DETAILED DESCRIPTION OF THE PREFERRED EMBODIMENTS

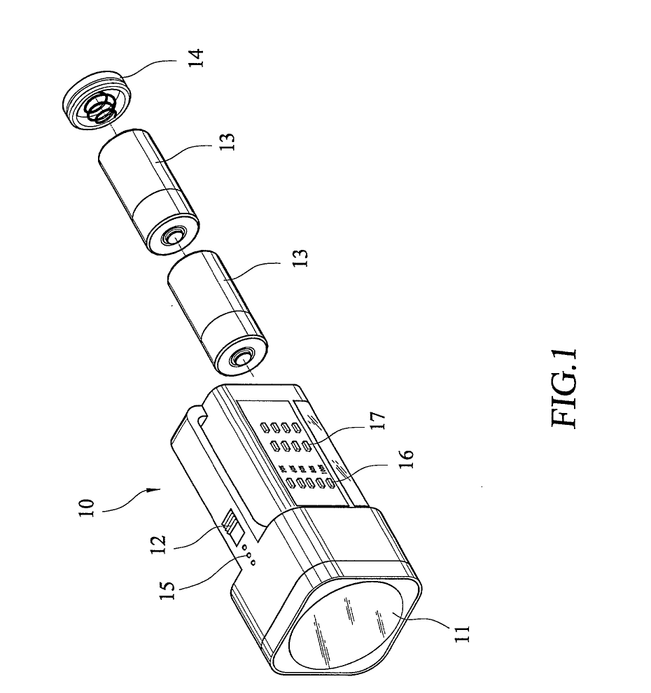

Please refer to FIG. 1 that is a perspective view of a portable energy-saving lighting device 10 according to a first embodiment of the present invention in the form of a flashlight. As shown, the flashlight 10 mainly includes a lamp unit 11, a power switch 12, a plurality of batteries 13, a battery compartment cap 14, and a plurality of indicating lights 15.

The flashlight 10 is further provided at a suitable position with a plurality of illumination-setting keys 16, with which a user may conveniently control an illuminative level of the lamp unit 11. In the illustrated embodiment, there are five illumination-setting keys 16 separately representing five different illuminative levels, for example, 20%, 40%, 60%, 80%, and 100%. The user may depress one of these illumination-setting keys 16 to set the lamp unit 11 to a desired illuminative level by changing the pulse width of an output signal to the light 11. When the user is in an environment that does not need high illumination, or when the user wants to save electric energy, he or she may simply depress one of the illumination-setting keys 16 representing a lower illuminative level to reduce the illumination of the lamp unit 11.

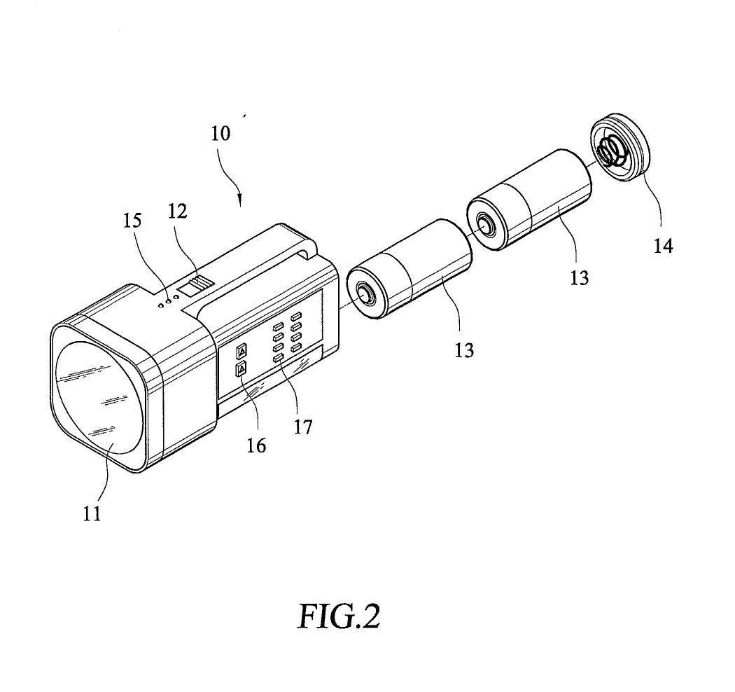

In the flashlight 10 according to the first embodiment of the present invention, the illumination-setting keys 16 may also be limited to only two keys, namely, an illumination-up key and an illumination-down key, as shown in FIG. 2. In this case, the illumination of the lamp unit 11 is digitally adjusted. The user needs only to depress the illumination-up key and the illumination-down key to increase and reduce, respectively, the illuminative level of the lamp unit 11. For example, the present invention may be so designed that each time the up or the down key is depressed, a pulse width of the flashlight is increased or decreased, respectively, by 10%. Of course, it is also possible to control changes in pulse width through a known variable resistor, in order to adjust the illumination of the lamp unit 11.

Moreover, the flashlight 10 according to the first embodiment of the present invention is also provided with a plurality of function keys 17 for users to perform other functions provided with the present invention. These functions may include, for example, a power-failure emergency light, an emergent help light, a dim light, etc.

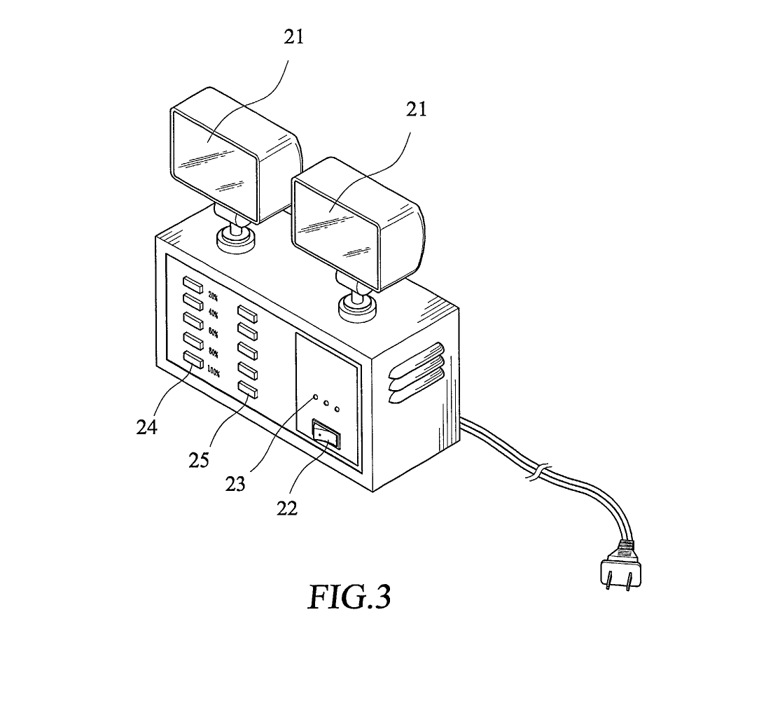

FIG. 3 is a perspective view of a second embodiment of the portable energy-saving lighting device 10 of the present invention in the form of an emergency light. The emergency light 10 mainly includes at least one lamp unit 21, a power switch 22, a plurality of indicating lights 23, a plurality of illumination-setting keys 24, and a plurality of function keys 25.

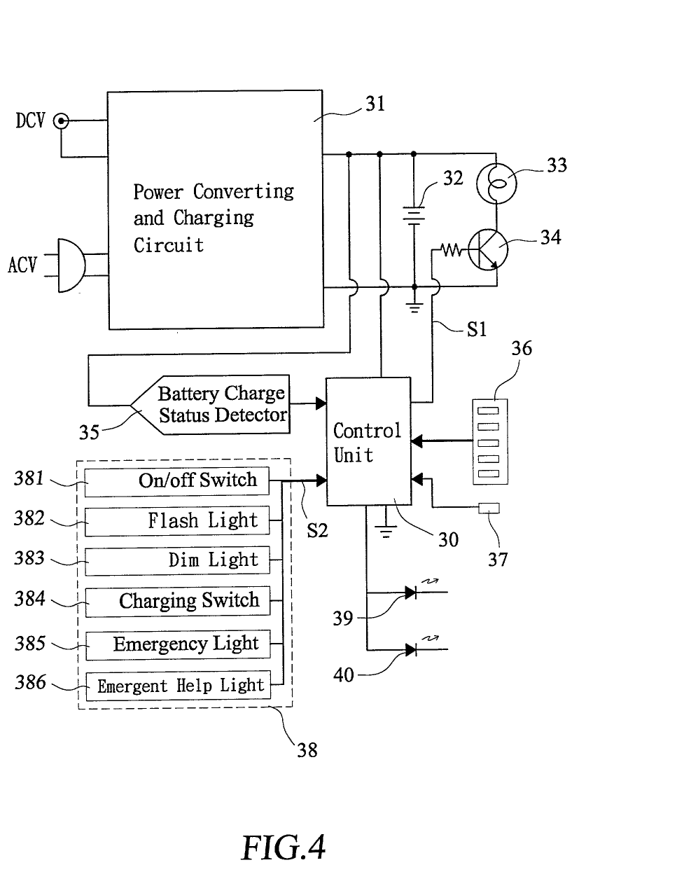

Please refer to FIG. 4 that is a control circuit diagram for the portable energy-saving lighting device of the present invention. The control circuit includes a control unit 30 for controlling various functions provided with the present invention and the illuminative level of the lamp unit thereof; a power converting and charging circuit 31 for converting an alternating power source ACV into a direct output voltage Vout, so that a rechargeable battery 32 of the present invention is charged with the output voltage Vout in normal times and can be used in an emergency, such as a power failure; at least one bulb 33 for emitting light; and a bulb illumination control switch 34 for turning on or off the bulb 33, as well as controlling the illumination of the bulb 33.

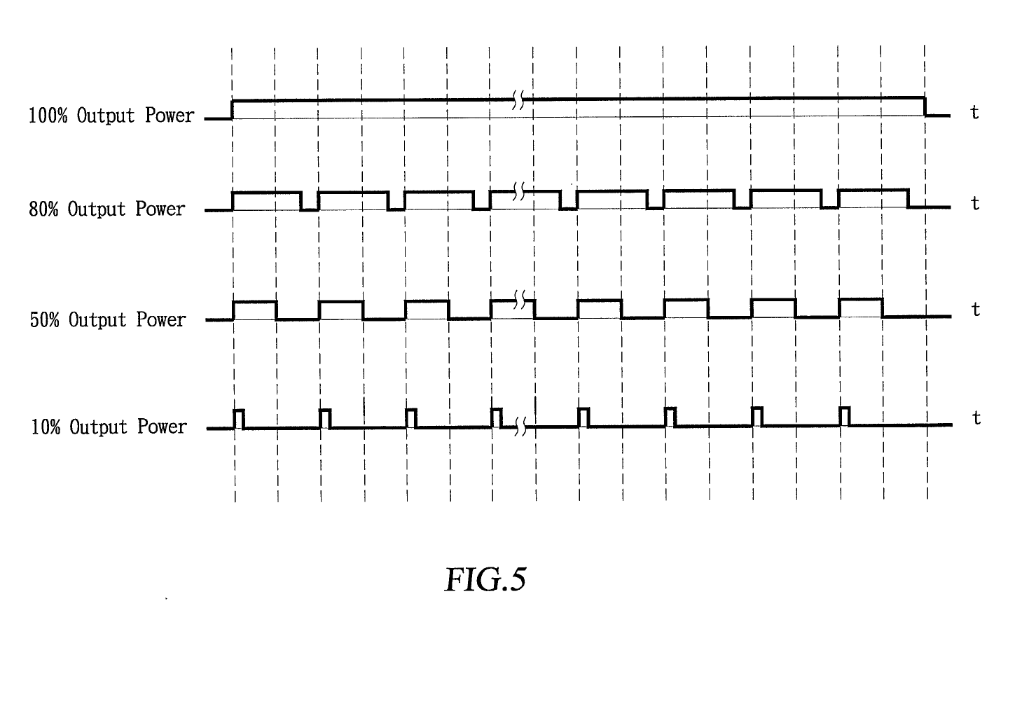

In the present invention, the illumination of the bulb 33 is controlled through pulse width modulation. Please refer to FIG. 5 that shows different pulse-width modulation signals for controlling the bulb illumination in the present invention. As mentioned above, the portable energy-saving lighting device 10 of the present invention uses the control unit 30 to control the illumination of the bulb 33 and to select other functions available from the present invention.

An illumination-setting unit 36 includes a plurality of setting keys for the user to set a desired illuminative level for the bulb 33. When the user depresses a key on the illumination-setting unit 36 (see FIG. 4) to set a desired illuminative level for the bulb 33, a setting signal is sent to and received by the control unit 30. On receipt of the setting signal, the control unit 30 sends out an illumination control signal S1 to the bulb illumination control switch 34 for the same to control the illumination of the bulb 33.

Each key on the illumination-setting unit 36 may be preset to a preset illuminative level, such as 50% or other percentage. The bulb illumination is controlled with the control unit 30 through pulse width modulation. More specifically, the control unit 30 turns the bulb illumination control switch 34 on or off at a high frequency. In this way, electric energy is saved while human eyes would not perceive the on and off of the bulb 33 at high frequency.

For example, when an illumination-setting key 36 representing an illuminative level of 50% is depressed, the control unit 30 will output a high-frequency pulse signal to the bulb illumination control switch 34, so that the latter is on for an average of 50% of the time period during which the portable energy-saving lighting device is switched on, and disabled (off) during the rest 50% of time. Or, when an illumination-setting key 36 representing an illuminative level of 100% is depressed, the bulb illumination control switch 34 is enabled all the time. Or, when an illumination-setting key 36 representing an illuminative level of 10% is depressed, the bulb illumination control switch 34 is enabled for an average of 10% of the time period during which the portable energy-saving lighting device is switched on, and disabled during the rest 90% of time. However, since the bulb illumination control switch 34 is alternately on and off at high frequency, and due to the after-vision of human eyes, the user would not perceive a flicker bulb 33 while an object of saving electric energy has been achieved.

The control circuit diagram of FIG. 4 also includes a battery charge status detecting circuit 35 electrically coupled to the control unit 30 for detecting a charge status of the rechargeable battery 32. An emergent help light enabling switch 37 is also coupled to the control unit 30 for enabling an emergent help signal light provided with the present invention. When the user, for example, encounters a disaster or gets lost in mountains or the wild, he or she may use the emergent help light enabling switch 37 to send out a series of flash light signals for help.

The control circuit of the present invention also includes a charge indicating light 39 that lights up when the portable energy-saving lighting device is in the course of charging; and a battery-low indicating light 40 that lights up when the battery 32 is low.

The portable energy-saving lighting device 10 of the present invention may be designed to include many other functions. The user may select a desired function through a function-selecting switch block 38. When doing so, the function-selecting switch block 38 sends out a function-selecting signal S2 that is received and executed by the control unit 30. For example, the user may manually switch the portable energy-saving lighting device 10 from an emergency light to a flashlight or a dim light for using outdoors.

When the user selects the function-selecting switch for a charger, the power converting and charging circuit 31 is enabled to charge the rechargeable battery 32. Meanwhile, the battery charge status detecting circuit 35 would detect a power level of the rechargeable battery 32 from time to time. In the event the battery 32 is detected as being low in power, the battery-low indicating light 40 would light up. And, when the portable energy-saving lighting device 10 is in the course of charging, the charge indicating light 39 will become on. The battery charge status detecting circuit 35 is also capable of detecting the charging condition of the battery 32. When the battery 32 is fully charged, the circuit 35 sends a signal to the control unit 30, so that the power converting and charging circuit 31 automatically stops charging under control of the control unit 30.

The present invention may also serve as a battery discharge protection. When the battery 32 discharges and an output voltage of the battery 32 exceeds a specified limit thereof, the present invention will immediately cause the battery 32 to stop discharging to avoid a damage battery.

The present invention may also serve as an emergency light during a power failure. When the supply of commercial power is in a normal condition, the power converting and charging circuit 31 works as a charging circuit to charge the battery 32; and when there is a power failure, the power converting and charging circuit 31 of the present invention automatically switches to the battery 32 to supply power needed for the present invention to function normally.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A portable energy-saving lighting device, comprising:
at least one battery for supplying an electrical power energy for the lighting device;
at least one lamp unit for emitting light;
an illumination control switch electrically connected in series with the lamp unit and then connected across the battery;
an illumination-setting unit for setting a plurality of illumination levels for the lamp unit and generating an illumination control signal corresponding to one of the illumination levels; and
a control unit for receiving said illumination control signal from the illumination-setting unit, and outputting an adjustable pulse-width modulation signal to control the illumination control switch, thereby adjusting the illumination of the lamp unit in accordance with the illumination level set by the illumination-setting unit.

2. The portable energy-saving lighting device as claimed in claim 1, wherein the illumination-setting unit comprises a plurality of illumination-setting keys for each setting a percentage illumination level for the lamp set.

3. The portable energy-saving lighting device as claimed in claim 1, wherein the illumination-setting unit comprises an illumination-up key and an illumination-down key to increase and reduce the illuminative level of the lamp unit respectively.

4. The portable energy-saving lighting device as claimed in claim 1, wherein the illumination-setting unit comprises a variable resistor to adjust the illuminative level of the lamp unit.

5. The portable energy-saving lighting device as claimed in claim 1, further comprising an emergent help light enabling switch coupled to the control unit for enabling an emergent help signal light.

6. The portable energy-saving lighting device as claimed in claim 1, further comprising a power converting and charging circuit for charging the battery.
